(19) United States
(12) Patent Application Publication
(10) Pub. No.: US 2026/0263905 A1
(43) Pub. Date: Sep. 10, 2026

(54) Interactive Virtual Chess Game

(71) Applicant: Samuel Torres, Ruskin, FL (US)

(72) Inventor: Samuel Torres, Ruskin, FL (US)

(21) Appl. No.: 19/270,563

(22) Filed: Jul. 16, 2025

Related U.S. Application Data
(60) Provisional application No. 63/767,732, filed on Mar. 6, 2025.

(51) Int. Cl. A63F 3/02; A63F 13/822

(52) U.S. Cl. CPC A63F 3/02; A63F 13/822

(57) ABSTRACT

An interactive virtual chess game is provided. The game is a virtual game wherein each chess piece is modeled as a controllable character classified according to standard chess hierarchy, including pawns, bishops, knights, rooks, queens, and kings, each possessing distinct attributes and combat capabilities. The game enforces standard chess movement rules except when a player attempts a capture an opponent's piece, the game initiates a transition from the chessboard to a combat environment thematically linked to the defending piece. These environments vary and include historical, fantasy, or science fiction settings, each featuring unique terrain and audiovisual characteristics. Combat engagements between the two pieces then occur in real time, utilizing each piece's unique weapons, abilities, and special features. Victory or defeat in combat determines the capture outcome, with the winning piece occupying the contested square.

### CROSS-REFERENCE TO RELATED APPLICATION

The present application claims priority to, and the benefit of, U.S. Provisional Application No. 63/767,732, which was filed on Mar. 6, 2025, and is incorporated herein by reference in its entirety.

### FIELD OF THE INVENTION

The present invention relates generally to the field of chess. More specifically, the present invention relates to a virtual chess game that integrates traditional chess rules with immersive real-time combat mechanics. Accordingly, the present disclosure makes specific reference thereto. Nonetheless, it is to be appreciated that aspects of the present invention are also equally applicable to other like applications, devices, and methods of manufacture.

### BACKGROUND

Chess has been a globally recognized strategy game for centuries, appreciated for its reliance on logic, foresight, and tactical planning. Despite its enduring appeal, traditional chess gameplay remains static and rule-bound, which can limit its ability to engage modern audiences seeking more interactive and dynamic entertainment. The standard mechanics of turn-based piece movement and automatic capture resolution may not appeal to players who prefer more immersive and action-oriented experiences. Additionally, younger audiences and those accustomed to interactive video games often find traditional chess lacking in audiovisual engagement and replay variability. The rise of digital platforms has led to increased experimentation in game formats, yet most adaptations of chess retain core mechanical limitations without substantial innovation in interactivity. Furthermore, the binary outcome of capture attempts in standard chess provides little room for strategic nuance once a piece is moved into position. There is also a growing market demand for games that combine strategic thinking with real-time skill-based combat, offering users a hybrid experience. Consequently, the absence of combat-driven resolution mechanisms in chess games represents a gap that can be addressed through technological and design innovation.

Therefore, there exists a long-felt need in the art for an interactive virtual chess game that maintains the strategic integrity of traditional chess while enhancing player engagement through interactive mechanics. There also exists a long-felt need in the art for an interactive virtual chess game that introduces dynamic, skill-based resolution methods for chess piece captures. Moreover, there exists a long-felt need in the art for an interactive virtual chess game that is compatible across multiple smart platforms and capable of delivering customizable, immersive environments.

The subject matter disclosed and claimed herein, in one embodiment thereof, comprises an interactive virtual chess game that integrates traditional chess rules with immersive real-time combat mechanics. The game is a virtual game wherein each chess piece is modeled as a controllable character classified according to standard chess hierarchy, including pawns, bishops, knights, rooks, queens, and kings, each possessing distinct attributes and combat capabilities. The game enforces standard chess movement rules except when a player attempts a capture an opponent's piece, the game initiates a transition from the chessboard to a combat environment thematically linked to the defending piece. These environments vary and include historical, fantasy, or science fiction settings, each featuring unique terrain and audiovisual characteristics. Combat engagements between the two pieces then occur in real time, utilizing each piece's unique weapons, abilities, and special features. Victory or defeat in combat determines the capture outcome, with the winning piece occupying the contested square. The system further includes downloadable content to expand environments, characters, rule sets, and gameplay modes. The invention also comprises a method of play wherein players alternate moves, initiate real-time combat upon attempted captures, and ultimately win the game by eliminating the opponent's king through successful combat.

In this manner, the interactive virtual chess game of the present invention accomplishes all the foregoing objectives and provides an improved chess game that introduces real-time combat engagements to resolve chess piece captures, thereby enhancing engagement while retaining strategic depth. The incorporation of piece-specific abilities and environment-driven dynamics addresses the need for interactive and customizable gameplay. The invention further maintains adherence to conventional chess rules for movement and overall structure, preserving the strategic elements valued by traditional players while offering additional layers of depth for modern audiences. In addition, the cross-platform compatibility and extensibility through downloadable content meet the demand for accessible, evolving gameplay experiences. As a result, the interactive virtual chess game provides a comprehensive solution to the problem of static and uninspiring traditional chess formats.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an interactive virtual chess game that combines traditional chess with interactive 1v1 combat mechanics during capture events. The game is implemented across multiple digital platforms, including standalone software, web-based applications, and smart devices.

The game is comprised of a virtual chessboard that tracks the positions and types of all active chess pieces and enforces standard movement and capture rules. Each chess piece functions as a controllable character, with control mechanisms adaptable to various input devices such as touchscreens, keyboards, mice, controllers, and voice commands.

Traditional chess movement rules are maintained, but capture attempts of opponent's pieces trigger a transition to a real-time combat engagement within a specialized combat environment. These environments may represent various thematic realms and are selectable by the defending player. During the transition, the square involved in the attempted capture becomes a portal to the combat environment, which includes unique terrain, lighting, audio, and interactive features.

Chess pieces are categorized into traditional types such as pawns, bishops, knights, rooks, queens, and kings. Each category is assigned specific abilities and attributes to support distinct tactical approaches in combat. Pawns utilize basic weapons, energy shields, projectiles, duplicates, cloaks, and movement enhancements. Knights function as mounted units with close-range weapons, energy shields, and summoning abilities. Bishops serve as levitating spellcasters with stealth and regeneration capabilities. Rooks act as heavy melee units with seismic attacks and projectile capabilities. Queens operate as versatile units with psychic, levitation, and weapon-based abilities. Kings represent hybrid units with superior abilities, anti-psychic defenses, and advanced weapons.

Combat outcomes determine whether the attacking or defending piece is removed from the board. A successful attacker replaces the defeated defender on the target square, while a failed attacker is removed, allowing the defender to maintain position. Additional gameplay modifiers include environmental hazards, time limits, power scaling, and context-based abilities.

The invention also includes a method of use involving initiation of the game, alternation of turns under traditional chess rules, activation of combat transitions upon capture attempts, execution of real-time combat using classified piece abilities, and resolution of captures based on combat outcomes. Victory is achieved by eliminating the opposing king in combat, thereby concluding the game.

Accordingly, the interactive virtual chess game of the present invention is particularly advantageous as it provides an improved chess game that introduces real-time combat engagements to resolve chess piece captures, thereby enhancing engagement while retaining strategic depth. The incorporation of piece-specific abilities and environment-driven dynamics addresses the need for interactive and customizable gameplay. The invention further maintains adherence to conventional chess rules for movement and overall structure, preserving the strategic elements valued by traditional players while offering additional layers of depth for modern audiences. In addition, the cross-platform compatibility and extensibility through downloadable content meet the demand for accessible, evolving gameplay experiences. As a result, the interactive virtual chess game provides a comprehensive solution to the problem of static and uninspiring traditional chess formats, thereby overcoming the limitations of existing chess games known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical schematic view of features of one potential embodiment of an interactive virtual chess game of the present invention in accordance with the disclosed architecture;

FIG. 2 illustrates a graphical schematic view of abilities of a pawn of one potential embodiment of an interactive virtual chess game of the present invention in accordance with the disclosed architecture;

FIG. 3 illustrates a graphical schematic view of abilities of a bishop of one potential embodiment of an interactive virtual chess game of the present invention in accordance with the disclosed architecture;

FIG. 4 illustrates a graphical schematic view of abilities of a knight of one potential embodiment of an interactive virtual chess game of the present invention in accordance with the disclosed architecture;

FIG. 5 illustrates a graphical schematic view of abilities of a rook of one potential embodiment of an interactive virtual chess game of the present invention in accordance with the disclosed architecture;

FIG. 6 illustrates a graphical schematic view of abilities of a queen of one potential embodiment of an interactive virtual chess game of the present invention in accordance with the disclosed architecture;

FIG. 7 illustrates a graphical schematic view of abilities of a king of one potential embodiment of an interactive virtual chess game of the present invention in accordance with the disclosed architecture; and

FIG. 8 illustrates a flowchart of a method of using one potential embodiment of an interactive virtual chess game of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an interactive virtual chess game that maintains the strategic integrity of traditional chess while enhancing player engagement through interactive mechanics. There also exists a long-felt need in the art for an interactive virtual chess game that introduces dynamic, skill-based resolution methods for chess piece captures. Moreover, there exists a long-felt need in the art for an interactive virtual chess game that is compatible across multiple smart platforms and capable of delivering customizable, immersive environments.

The present invention, in one exemplary embodiment, is comprised of an interactive virtual chess game that merges the foundational structure of traditional chess with real-time 1v1 combat mechanics during capture events. The game is designed for implementation across various digital platforms, including standalone software, web-based applications, and smart devices.

The game features a virtual chessboard responsible for monitoring the positions and classifications of all active chess pieces while enforcing conventional movement and capture rules. Each chess piece is modeled as a controllable character, with input compatibility across devices such as touchscreens, keyboards, mice, controllers, and voice-based systems.

While conventional chess movement rules are preserved, the game introduces an interactive combat phase triggered by capture attempts. When an attacking piece targets an opponent's piece, the corresponding square transitions into a portal that transports both pieces into a specialized combat environment. These environments are selectable by the defending player and feature distinct themes, terrain types, lighting effects, audio elements, and interactive features.

Chess pieces are organized according to traditional classifications—pawns, bishops, knights, rooks, queens, and kings. Each category possesses distinct abilities and attributes tailored to support varied tactical roles in combat. Pawns are equipped with basic weapons, shields, projectiles, decoys, camouflage gear, and mobility aids. Knights function as mounted warriors with melee weaponry, energy-based defenses, and repositioning capabilities. Bishops act as spellcasting units with levitation, stealth, and regenerative abilities. Rooks serve as high-durability combatants with seismic and projectile attacks. Queens fulfill multi-role functions using psychic manipulation, levitation, and versatile weapon systems. Kings operate as superior hybrid units with enhanced resistance to psychic interference and access to advanced melee and defensive equipment.

Combat outcomes dictate whether the attacking or defending piece is eliminated from the board. If the attacker prevails, the defender is removed, and the attacker occupies the contested square. Conversely, a failed assault results in the removal of the attacking piece, allowing the defender to retain position. Additional gameplay dynamics may include variable environmental hazards, timed engagements, power balancing, and ability activation based on situational context.

The invention further encompasses a method of use, which includes initiating the game, alternating turns according to standard chess rules, triggering combat transitions during capture attempts, conducting real-time engagements using categorized abilities, and resolving captures based on combat results. The game concludes when a player successfully eliminates the opponent's king in combat.

Thus, the present interactive virtual chess game offers a significantly enhanced version of traditional chess by incorporating real-time combat sequences for piece captures. This approach preserves the strategic foundation of chess while introducing new levels of interactivity and customization. The inclusion of piece-specific combat roles and thematically driven environments provides increased engagement and replayability. Furthermore, adherence to standard chess rules ensures familiarity for traditional players, while cross-platform compatibility and expandability through downloadable content address the evolving preferences of modern users. This combination effectively addresses the limitations of conventional chess formats by offering a dynamic and immersive alternative.

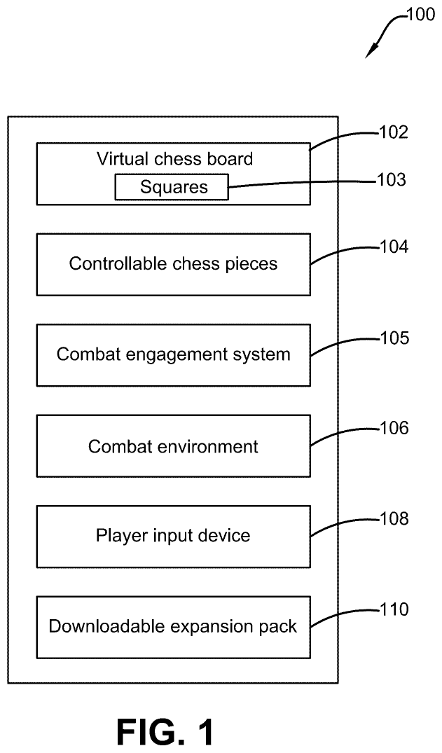

Referring initially to the drawings, FIG. 1 illustrates a graphical schematic view of features of one potential embodiment of an interactive virtual chess game 100 of the present invention in accordance with the disclosed architecture. The game 100 may achieve a unique combination of traditional chess and immersive 1v1 combat sequences by preserving core strategic elements of traditional chess while introducing an interactive resolution mechanism for chess piece captures. The game 100 may be implemented in various formats including, but not limited to, standalone software, web-based platforms, or applications compatible with smart devices such as smartphones, tablets, smart TVs, and game consoles.

The game 100 may be comprised of a virtual chessboard 102, which is preferably, but not limited to, a digitally rendered 8×8 grid displayed on a graphical user interface. The virtual chessboard 102 may track the coordinates and types of all active chess pieces 104 and enforce movement and capturing rules consistent with standard chess rules and regulations. The chessboard 102 may be comprised of squares 103. Each chess piece 104 may be modeled as a controllable character within the game 100. The control mechanism for each chess piece 104 may vary based on the input devices 108 used, such as, but not limited to, touch screens, keyboards, mice, game controllers, motion sensors, voice commands, etc.

The foundational layer of gameplay of the game 100 may remain consistent with standard chess, wherein players alternate turns to maneuver pieces 104 across the virtual chessboard 102 according to conventional chess movement rules. However, when a piece 104 attempts to capture an opposing piece 104, rather than resolving the action automatically via conventional chess rules, the game 100 initiates a real-time combat engagement system 105 in a designated combat environment 106. The environment 106 may correspond to diverse eras or fantasy realms such as, but not limited to, Egyptian deserts, Roman arenas, medieval territories, urban warfare zones, etc. These backgrounds 106 may be dynamically switched by user preference or system configuration. More specifically, when a player initiates a capture attempt on an opponent's piece 104 via moving their piece 104, the virtual chessboard 102, the square 103 involved in the attack may initiate a transition sequence, transforming into a combat portal that transports both the attacking and defending pieces 104 into an alternate combat environment 106. The environment 106 may be thematically linked to the defending piece 104 and selected by the defending player from a predefined set of settings. Each environment 106 may feature distinct terrain geometries, lighting effects, ambient sounds, and interactive elements.

The game 100 may be comprised of downloadable content (DLC) 110 which may introduce new character aesthetics, weapon models, environment skins, and soundtracks. The downloadable content 110 may also expand available combat environments 106, incorporating additional thematic elements, such as, but not limited to, mythological realms, science fiction zones, post-apocalyptic landscapes, and seasonal event maps. DLC 110 may include new challenge modes, alternate rule sets, and cooperative multiplayer scenarios that modify or expand the core gameplay framework.

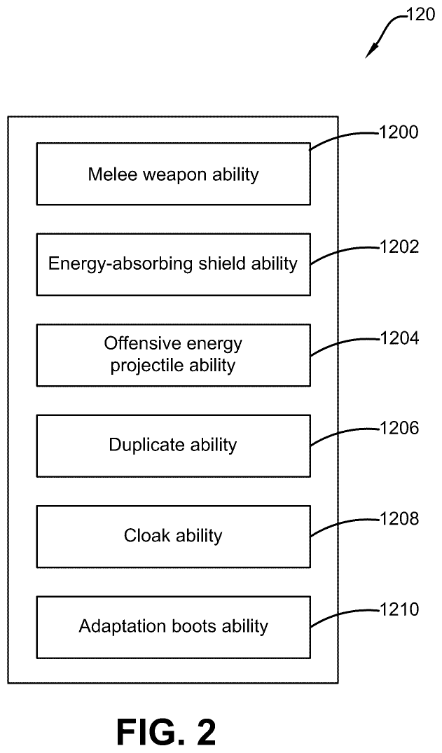

Chess pieces 104 may be classified according to the traditional hierarchy of chess, including Pawns 120, Bishops 122, Knights 124, Rooks 125, Queens 126, and Kings 128. Each classification may possess unique attributes, abilities, and combat strategies that distinguish gameplay performance and tactical application. By way of example, pawns 120 (as seen in FIG. 2) may be equipped with basic melee weapons 1200 and a magical energy-absorbing shield 1202. This absorbed energy may be redirected as offensive projectiles 1204. Pawns 120 may additionally utilize magic to create temporary duplicates 1206 to enable flanking attacks. In expanded configurations, pawns 120 may also be equipped with camouflage cloaks 1208 for temporary invisibility and terrain adaptation boots 1210 that provide environment-specific movement bonuses.

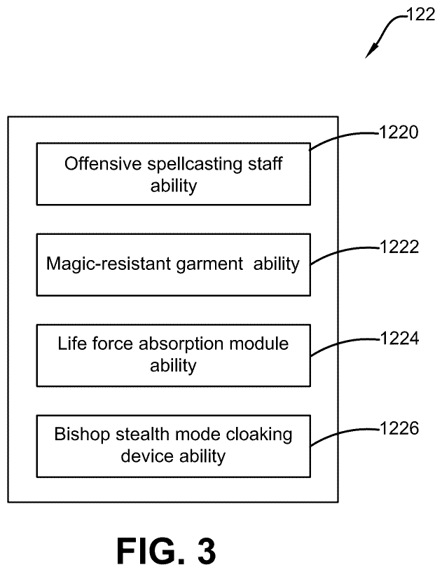

Bishops 122 (as seen in FIG. 3) may operate as airborne spellcasters, using staffs 1220 to launch offensive magic from range. Bishops 122 may be capable of levitation to avoid ground-based attacks and may become temporarily invisible through stealth mode cloaking devices 1226 for ambush tactics. Bishops 122 may wear garments 1222 that provide diminishing magical protection and may include life force absorption modules 1224 that allow regeneration of health or magic reserves upon a successful attack.

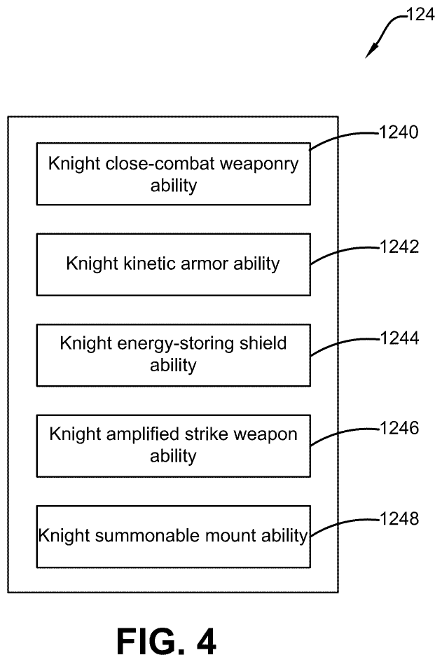

Knights 124 (as seen in FIG. 4) may serve as mounted units outfitted with close-combat weaponry 1240, kinetic armor 1242, and energy-storing shields 1244. The energy stored in shields 1244 may be redirected through weapon systems 1246 for amplified strikes. Knights 124 may summon mounts 1248 for rapid repositioning.

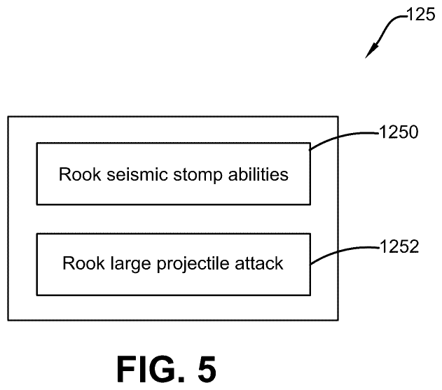

Rooks 125 (as seen in FIG. 5) may be characterized as heavy combatants with high durability and close-range impact power. Rooks 125 may deploy seismic stomp abilities 1250 to destabilize enemies and hurl large projectiles 1252 as ranged attacks.

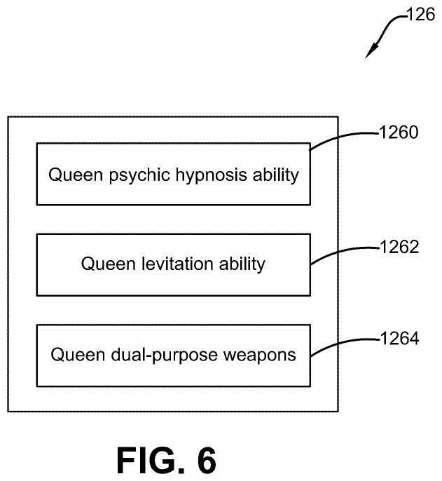

Queens 126 (as seen in FIG. 6) may operate as multi-role combatants possessing both psychic manipulation and precision weaponry. Queens 126 may use hypnosis 1260 to disarm enemies or compel surrender, levitate 1262 for vertical mobility, and use weapons 1264 for dual-function offensive and defensive engagement.

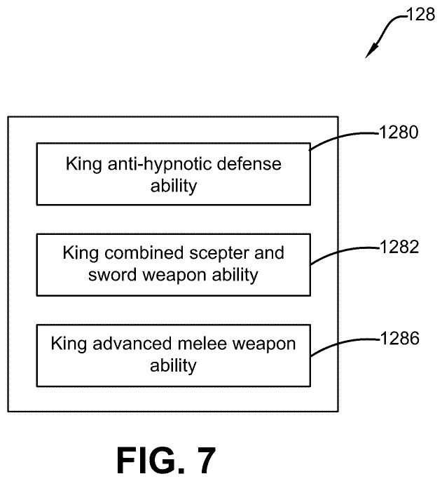

Kings 128 (as seen in FIG. 7) represent apex hybrid units with abilities derived from or surpassing those of other pieces 104. Kings 128 may resist psychic manipulation through anti-hypnotic features 1280 and may wield weapons 1282 such as, but not limited to, both a scepter and sword. The weapons 1282 may be used to deflect magical projectiles and enable advanced melee defense 1286.

The result of each combat encounter within the game 100 may determine whether the attacking chess piece 104 captures the defending piece 104. A successful capture may result in the removal of the defending piece 104 from the virtual chessboard 102, and the attacking piece 104 may then occupy the targeted square 103 in accordance with traditional chess rules. A failed combat attempt may lead to the elimination of the attacking piece 104, allowing the defending piece 104 to retain its position on the square 103 and gain the initiative for the next move. Additional gameplay modifiers may include environmental hazards, time-limited engagement sequences, power disparity scaling, and context-sensitive ability activations, all of which may further diversify combat strategy and chessboard tactics.

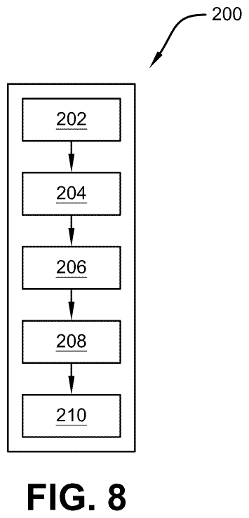

The present invention is also comprised of a method of using 200 the game 100, as seen in FIG. 8. First, a game 100 is provided comprised of a virtual chessboard 102 comprised of squares 103 and a plurality of chess pieces 104 including pawns 120, bishops 122, knights 124, rooks 125, queens 126, and kings 128, wherein the chess pieces 104 are modeled as controllable characters, and the game 100 is configured to be implemented via at least one smart device or computing platform [Step 202]. Then, the game 100 can be initiated wherein players take alternating turns to move chess pieces 104 across the virtual chessboard 102 in accordance with traditional chess rules, and the position of each piece 104 is tracked by the virtual chessboard 102 [Step 204]. Next, when a player attempts to capture an opposing chess piece 104, the square 103 associated with the target piece 104 initiates a transition sequence, transporting the attacking and defending pieces 104 into a combat environment 106 [Step 206]. Next, a real-time combat engagement 105 is conducted between the attacking and defending pieces 104, during which each piece 104 the players may select and use each piece's 104 classified abilities, weapons, and attributes specific to its type such as, but not limited to, melee weapons 1200, shields 1244, or spells 1220 [Step 208]. Then, upon conclusion of the combat engagement 105, if the attacking piece 104 is victorious, the defending piece 104 is removed from the virtual chessboard 102 and the attacking piece 104 is placed on the corresponding square 103, or if the attacking piece 104 is defeated, it is removed and the defending piece 104 retains its position. Finally, the game 100 can be won when a player successfully eliminates the opposing king 128 through a victorious combat engagement 105, after which the game 100 terminates and the victorious player is declared the winner [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “interactive virtual chess game” and “game” are interchangeable and refer to the interactive virtual chess game 100 of the present invention.

Notwithstanding the foregoing, the interactive virtual chess game 100 of the present invention and its various components can be of any suitable size and configuration as is known in the art without affecting the overall concept of the invention, provided that they accomplish the above-stated objectives. One of ordinary skill in the art will appreciate that the size, configuration, and material of the interactive virtual chess game 100 as shown in the FIGS. are for illustrative purposes only, and that many other sizes and shapes of the interactive virtual chess game 100 are well within the scope of the present disclosure. Although the dimensions of the interactive virtual chess game 100 are important design parameters for user convenience, the interactive virtual chess game 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interactive virtual chess game comprising:
a plurality of chess pieces modeled as controllable characters, the plurality of chess pieces comprising pawns, bishops, knights, rooks, queens, and kings;
a virtual chessboard comprising a grid of a plurality of squares configured to track a position of the plurality of chess pieces;
a combat engagement system configured to initiate a real-time combat engagement between a first chess piece of the plurality of chess pieces and a second chess piece of the plurality of chess pieces when a first chess piece attempts to capture the second chess piece; and
a combat environment configured to receive the first chess piece and the second chess piece during the real-time combat engagement, wherein a result of the combat engagement determines whether the first chess piece captures the second chess piece.

2. The interactive virtual chess game of claim 1, wherein the virtual chess board is comprised of an 8×8 grid.

3. The interactive virtual chess game of claim 1, wherein the interactive virtual chess game is implemented in a web-based platform.

4. The interactive virtual chess game of claim 1, wherein the pawn is equipped with a melee weapon, a magical energy-absorbing shield, and is capable of redirecting an absorbed energy as an offensive projectiles.

5. The interactive virtual chess game of claim 1, wherein the pawn is configured to create temporary duplicates and utilize camouflage cloaks for temporary invisibility.

6. The interactive virtual chess game of claim 1, wherein the knight is equipped with a close-combat weaponry, a kinetic armor, and an energy-storing shields configured to redirect a stored energy through a weapon system.

7. The interactive virtual chess game of claim 1, wherein the bishop is equipped with a staff for launching an offensive magic, is capable of a levitation, and includes a garment providing a magical protection.

8. The interactive virtual chess game of claim 1, wherein the rook is configured as a heavy combatant capable of deploying a seismic stomp ability and hurling a projectile.

9. The interactive virtual chess game of claim 1, wherein the queen is equipped with a hypnosis capability and a levitation ability.

10. The interactive virtual chess game of claim 1, wherein the king is equipped with an anti-hypnotic ability and a weapons used to deflect a magical projectiles and provide a melee defense.

11. An interactive virtual chess game comprising:
a plurality of chess pieces modeled as controllable characters, the plurality of chess pieces comprising pawns, bishops, knights, rooks, queens, and kings;
a virtual chessboard comprising a grid of a plurality of squares configured to track a position of the plurality of chess pieces;
a combat engagement system configured to initiate a user-controlled real-time combat engagement between a first chess piece of the plurality of chess pieces and a second chess piece of the plurality of chess pieces when a first chess piece attempts to capture the second chess piece; and
a combat environment configured to receive the first chess piece and the second chess piece during the real-time combat engagement, wherein a result of the combat engagement determines whether the first chess piece captures the second chess piece.

12. The interactive virtual chess game of claim 11, wherein the virtual chess board is comprised of an 8×8 grid.

13. The interactive virtual chess game of claim 11, wherein the interactive virtual chess game is implemented in a smart device application.

14. The interactive virtual chess game of claim 11, wherein the pawn is equipped with a melee weapon, a magical energy-absorbing shield, and is capable of redirecting an absorbed energy as an offensive projectiles.

15. The interactive virtual chess game of claim 11, wherein the pawn is configured to create temporary duplicates and utilize camouflage cloaks for temporary invisibility.

16. The interactive virtual chess game of claim 11, wherein the knight is equipped with a close-combat weaponry, a kinetic armor, and an energy-storing shields configured to redirect a stored energy through a weapon system.

17. The interactive virtual chess game of claim 11, wherein the bishop is equipped with a staff for launching an offensive magic, is capable of a levitation, and includes a garment providing a magical protection.

18. The interactive virtual chess game of claim 11, wherein the rook is configured as a heavy combatant capable of deploying a seismic stomp ability and hurling a projectile.

19. The interactive virtual chess game of claim 11, wherein the queen is equipped with a hypnosis capability and a levitation ability.

20. A method of using an interactive virtual chess game, the method comprising the following steps:
providing an interactive virtual chess game comprised of a virtual chessboard comprised of a plurality of chess pieces;
initiating a game in which a first player and a second player take alternating turns to move a first chess piece of the plurality of chess pieces and a second chess piece of the plurality of chess pieces across the virtual chessboard in accordance with traditional chess rules; and
conducting a real-time combat engagement between the first chess piece and the second chess piece after the first chess piece attempts to capture the second chess piece, the real-time combat engagement using weapons, abilities, and attributes specific to each chess piece, and wherein the second chess piece is removed from the virtual chessboard if the first chess piece wins the real-time combat engagement.
